(19) United States
(12) Patent Application Publication
(10) Pub. No.: US 2010/0024985 A1
(43) Pub. Date: Feb. 4, 2010

(54) SHAPING FORMER AND SYSTEM FOR BUILDING GREEN-TIRE INCLUDING THE SAME

(76) Inventor: Hiroyuki ONIMATSU, Kobe-shi (JP)

Correspondence Address: BIRCH STEWART KOLASCH & BIRCH, PO BOX 747, FALLS CHURCH, VA, 22040-0747, US

(21) Appl. No.: 12/435,004

(22) Filed: May 4, 2009

(30) Foreign Application Priority Data
Aug. 4, 2008 (JP) 2008-201017

(51) Int. Cl. B29D 30/24

(52) U.S. Cl. 156/396; 156/414

(57) ABSTRACT

A former used for shaping a green tire into a toroidal shape and a green tire building system including two formers are disclosed. The former comprises: a pair of bead-lock devices supported by a rotatable tubular shaft in which a central shaft is disposed; a rotational-to-linear motion converter converting rotational motion of the central shaft relative to the tubular shaft to linear motion for causing the bead-lock devices to come close to each other or to get away from each other; a single electric motor; and a clutch for switching the transmission of the rotational motion of the motor to (A) only the central shaft to change the distance between the bead-lock devices or (B) both of the tubular shaft and central shaft to rotate the bead-lock devices. The building system comprises a turntable on which the two formers are disposed towards different directions so that by turning the turntable, each of the formers positions towards a first drum and a second drum in turn.

### BACKGROUND OF THE INVENTION

The present invention relates to a system for building a green tire including a shaping former, more particularly to a structure of the shaping former including an electric motor used two ways to rotate a pair of bead-lock rings and change the distance between the bead-lock rings.

Heretofore, in order to manufacture a radial tire, a so called two-stage building method has been widely employed. FIGS. 14(a)-14(c) and 16(a)-16(b) schematically show typical steps of such two-stage building method in chronological order.

In the first building stage of this method, as shown in FIG. 14(a), tire constructional components (b) including a carcass ply (b1) are wound on a cylindrical first drum (A). Then, as shown in FIG. 14(b), an annular assembly of a bead core (c) and a rubber bead apex (f) is fitted on the wound components (b), and thereby a cylindrical green tire main body (B) is formed. Further, each of the edge portions (be) of the cylindrical green tire main body (B) axially outside the bead cores (c) is turned up as shown in FIG. 14(c) and FIG. 15 (turnup step).

In the second building stage, as shown in FIG. 16(a), the green tire main body (B) is set on a shaping former (E) having a pair of bead-lock devices El which can secure the bead cores (c) or bead portions of the green tire main body (B) by pressing the carcass ply (b1) against the bead cores (c) from the radially inside thereof. Then, by decreasing the distance between the bead-lock devices E1, namely, the distance between the bead cores (c), the carcass ply portion between the bead cores is swelled into a toroidal shape so that, as shown in FIG. 16(b), the crown portion of the carcass comes into contact with the inside of a tread ring D which is an assembly of a tread rubber (d2) and a tread reinforcing belt (d1) which is formed separately and set in place beforehand (shaping step). In order to surely adhere the tread ring D to the green tire main body B, stitching rollers R are pressed against the outer surface of the tread ring D which is rotated together with the green tire main body B by rotating the bead-lock devices E1.

In this shaping former E, therefore, an electric motor and associated power transmission device, e.g. gears and the like for axially moving the bead-lock devices (E1) and an electric motor and associated power transmission device for rotating the bead-lock devices E1 are necessitated. Therefore, the sophisticated control of the two motors is required, and the structure of the former becomes complicated. Further, space-saving of the system is difficult.

### SUMMARY OF THE INVENTION

It is therefore, an object of the present invention to provide a shaping former and a green tire building system including the same, in which the number of the electric motor and power transmission device used in the shaping former is decreased and it is possible to simplify and downsize the structure of the former.

According to the present invention, a shaping former comprises:

a pair of bead-lock devices disposed side-by-side in the axial direction of the former and supporting the green tire main body at the positions of the bead cores from the radially inside of the green tire main body;

a rotatable tubular shaft supporting the bead-lock devices movably therealong but immovably therearound;

a central shaft disposed in the tubular shaft and being rotatable independently of the tubular shaft;

a motion converter converting rotational motion of the central shaft relative to the tubular shaft to linear motion for causing the bead-lock devices to come close to each other or to get away from each other;

a single electric motor; and

a clutch for switching transmission of the rotational motion of the single electric motor between a linear-motion mode and a rotational-motion mode, wherein

the linear-motion mode is such that the rotational motion of the single electric motor is transmitted to only the central shaft so as to cause the rotational motion of the central shaft relative to the tubular shaft, whereby the bead-lock devices come close to each other or get away from each other according to the direction of the rotational motion, and

the rotational-motion mode is such that the rotational motion of the single electric motor is transmitted to both of the tubular shaft and central shaft so that the bead-lock devices rotate together, without causing the relative rotational motion between the central shaft and the tubular shaft.

According to the present invention, a system for building a green tire comprises:

two of the shaping formers;

a first drum on which the cylindrical green tire main body is formed by winding the carcass ply and fitting the bead cores on the wound carcass ply;

a second drum on which an annular tread ring is formed by winding a tread reinforcing belt and a tread rubber; and

a turntable on which said two shaping formers are installed, the turntable is positioned between the first drum and the second drum so that by turning the turntable, each of the shaping formers is positioned toward and concentrically with the first drum and the second drum in turn.

### BRIEF DESCRIPTION OF THE DRAWINGS

FIG. 1 is a plan view showing a green tire building system according to the present invention.

FIG. 2 is a plan view showing two shaping formers installed on a turntable.

FIG. 3 is a side view of one of the shaping formers on the turntable.

FIG. 4 is a schematic side view showing a first drum and a first transfer device.

FIG. 5 is a schematic side view showing the first transfer device and the shaping former shown in FIG. 3.

FIG. 6 is a cross sectional view showing the substantial part of the shaping former.

FIG. 7 is a cross sectional view showing a part of a folding device.

FIG. 8 is a cross sectional view of a clutch.

FIG. 9 is a schematic side view showing a second drum and a second transfer device.

FIG. 10 is a side view showing the second transfer device and the shaping former shown in FIG. 5 on the turntable turned by 180 degrees.

FIGS. 11(a)-11(c) are cross sectional views of the folding device for explaining the function thereof.

FIG. 12 is a schematic cross sectional view of bead-lock devices in a linear-motion mode.

FIG. 13 is a schematic cross sectional view of the bead-lock devices in a rotational-motion mode.

FIGS. 14(a)-14(c) are schematic cross sectional views for explaining a first stage of building a radial tire.

FIG. 15 is a partial cross sectional view of the green tire main body.

FIGS. 16(a)-16(b) are schematic cross sectional views for explaining a second stage of building the radial tire.

### DESCRIPTION OF THE PREFERRED EMBODIMENTS

Embodiments of the present invention will now be described in detail in conjunction with accompanying drawings.

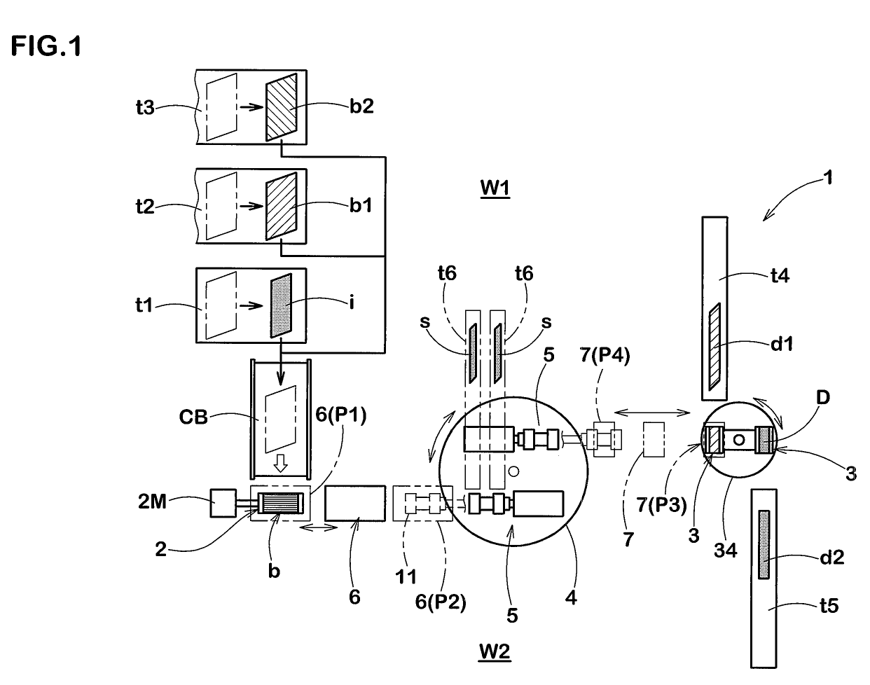

FIG. 1 shows a green tire building system 1 as an embodiment of the present invention. This system 1 includes a shaping former 5 as another embodiment of the present invention.

The green tire building system 1 comprises:
a first drum 2 for building a green tire main body B;
a second drum 3 for building a tread ring D;
a turntable 4 disposed between the first drum 2 and second drum 3;
two of the shaping formers 5 mounted on the turntable 4;
a first transfer device 6 for transferring the green tire main body B on the first drum 2 to one of the shaping formers 5; and
a second transfer device 7 for transferring the tread ring D on the second drum 3 to one of the shaping formers 5 on which the green tire main body B is set.

In this specification, unless otherwise noted, the expressions “axially inward”, “axially inner”, “axially inside” and the like used in connection with the cylindrical or substantially cylindrical bodies such as the drums, former and the like are meant for “toward”, “farther nearer to”, “side nearer to” the widthwise center or the center in the direction of the rotational axis of the body concerned. The expressions “radially inward”, “radially inner”, “radially inside” and the like are meant for “toward”, “farther nearer to”, “side nearer to” the rotational axis.

### First Drum 2

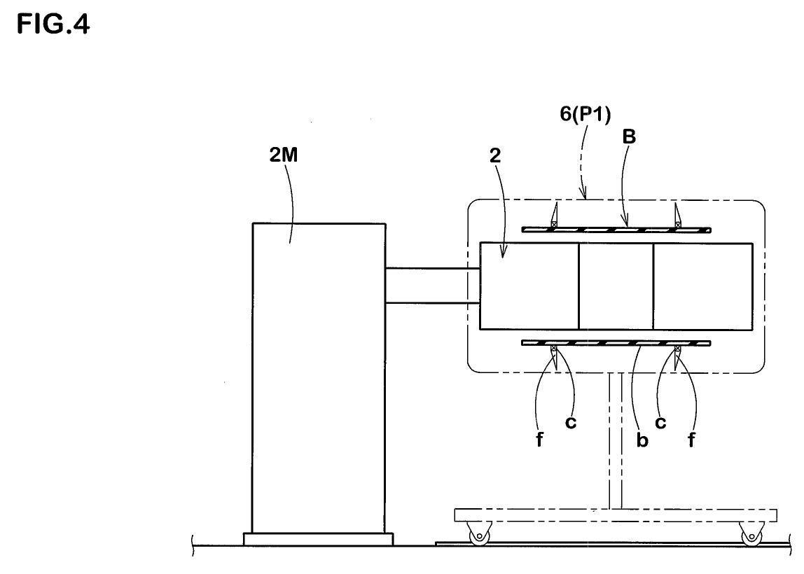

The first drum 2 is expandable-and-contractible and has a substantially cylindrical outer circumferential surface. The first drum 2 is rotatably cantilever supported by a housing main body 2M installed upright on the floor so that the rotational axis is laid horizontally as shown in FIG. 4.

On W1-side (see FIG. 1) of the first drum 2, there are disposed: a first service tray t1 for stocking a strip of innerliner rubber (i) cut into a specific length; a second service tray t2 for stocking a strip of carcass ply b1; and a third service tray t3 for stocking a strip of carcass ply b2.

The strips of the innerliner rubber (i) and carcass plies b1 and b2 are wound in sequence around the above-mentioned substantially cylindrical outer circumferential surface of the expanded first drum 2 to form a tubular tire constructional components (b).

In order to supply these strips to the first drum 2, in this embodiment, a single conveyer CB is disposed. In order to use the single conveyer CB in common to all of the service trays t1, t2 and t3, the service trays t1, t2 and t3 are provided at different heights so as to overlap vertically although in FIG. 1 the service trays are illustrated by developing horizontally for easy understanding. Of course it is possible to provided a plurality of conveyers CB between the first drum 2 and the service trays t1, t2 and t3, respectively. In this embodiment, since the number of the carcass plies is two, the number of the service trays for the carcass plies is two, but this may be varied corresponding to the number of the carcass plies.

### Second Drum 3

The second drum 3 is disposed on the 180-degree opposite side of the turntable 4 to the first drum 2. The second drum 3 is expandable-and-contractible, and the expanded second drum 3 has a substantially cylindrical outer circumferential surface or a profiled outer circumferential surface slightly curved correspondingly to the profile of the belt.

In this embodiment, two of the second drums 3 are coaxially rotatably mounted on a turntable 34.

On W1-side (upside in FIG. 1) of the second drums 3, there is disposed a fourth service tray t4 for stocking a strip of belt ply d1 cut into a specific length to be supplied to the second drum 3.

on W2-side (downside in FIG. 1) of the second drums 3, there is disposed a fifth service tray t5 for stocking a strip of tread rubber d2 to be supplied to the second drum 3.

With respect to the rotational center of the turntable 34, the service trays t4 and t5 are positioned diagonally opposite to each other, in other words, point-symmetry with respect to the rotational center of the turntable 34.

By turning the turntable 34 every 180 degrees, the two second drums 3 can be positioned so as to confront the service trays t4 and t5 by turns.

Thus, each of the second drums 3 is supplied with the belt ply strip and tread rubber strip in this sequence from the service trays t4 and t5 so that the belt ply d1 is wound on the second drum 3 and then the tread rubber d2 is wound therearound to form the above-mentioned annular tread ring D efficiently.

As to the tread rubber d2, a strip extruded into a width corresponding to that of the tread rubber d2 is used in the illustrated example. But, it is also possible to employ a tread rubber d2 formed by winding a narrow raw rubber tape a large number of times on the outside of the belt ply d1 previously wound on the second drum 2.

As to the tread reinforcing belt, a so called jointless band formed by helically winding at least one organic fiber cord a large number of times may be included in the tread ring D on the radially outside of the belt ply.

Turntable 4

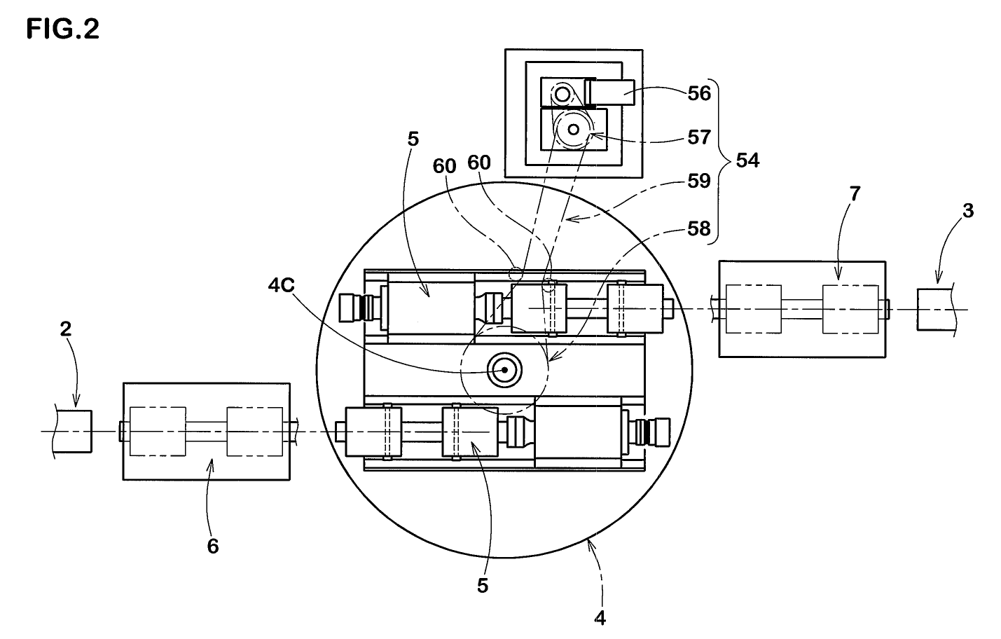

In order to turn the turntable 4, a turning device 54 is provided. As shown in FIG. 2, the turning device 54 in this embodiment comprises: an electric motor 56; a first sprocket 57 rotated by the electric motor 56 through reduction gears; a second sprocket 58 fixed to the central shaft of the turntable 4; a chain 59 wound between the first and second sprockets 57 and 58; and an idle sprocket 60 for giving a tension to the chain 59. By operating the electric motor 56, the turntable 4 is turned about its rotational center 4C.

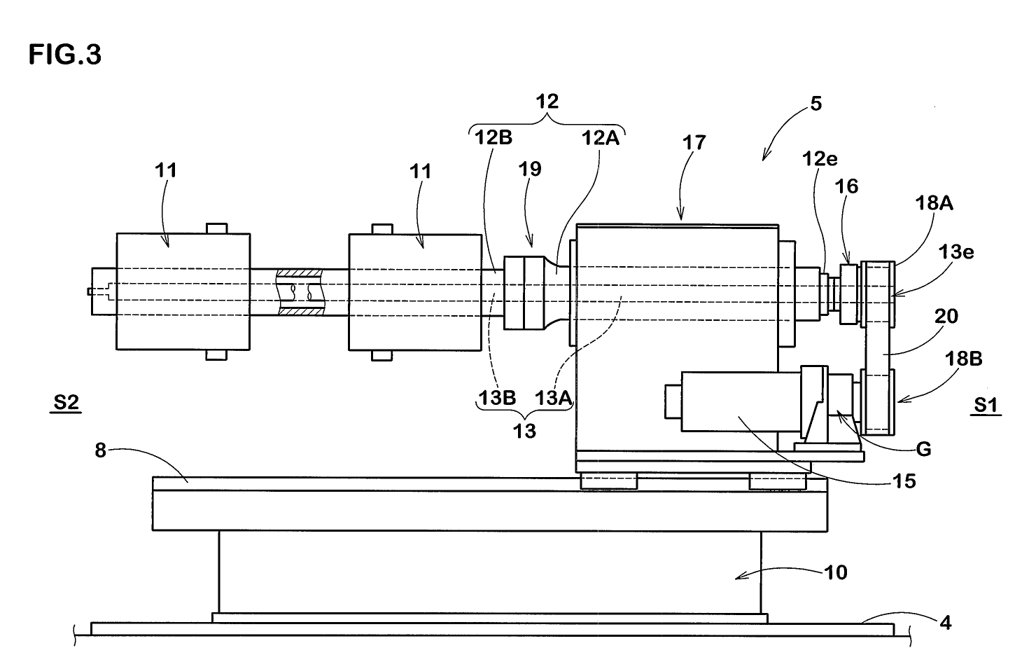

As shown in FIG. 3, the turntable 4 is provided with two pairs of horizontal rails 8. The horizontal rails 8 are fixed to the upper surface of the turntable 4 through a base 10. Each pair of the horizontal rails 8 support a main frame 17 of one of the shaping formers 5 movably in the horizontal direction so that as shown in FIG. 1 by solid line and imaginary line, a part (the undermentioned bead-lock devices 11) of the shaping former 5 can move between a position inside the turntable 4 and a position outside the turntable 4.

As to a device to move the main frame 17, in this embodiment, a hydraulic cylinder (not shown) disposed in the base 10 at a position beneath the rails is used, but another type of actuator, for example, a rack-and-pinion and a geared motor and the like can be used.

When turning the turntable 4, the shaping formers 5 can draw back to the position on the turntable 4 not to hit the first drum 2 and second drum 3, therefore, the installation area or footprint can be decreased so as to contribute to the space-saving.

### Shaping Formers 5

The two shaping formers 5 are as shown in FIG. 2, arranged point-symmetrically about the rotational center 4C of the turntable 4 so that by turning the turntable 4 every 180 degrees, the shaping formers 5 can concentrically align with the first drum 2 and second drum 3 by turns. Therefore, the transfer of the tire constructional components (b) from the first drum 2 to one of the shaping formers 5, and the transfer of the tread ring D from the second drum 3 to the other shaping former 5 can be made simultaneously and efficiently.

Thus, the green tire building system 1 in this embodiment can decrease the idle time of the shaping formers 5, and as a result, the production efficiency of the tire can be improved. As a result of such arrangement of the green tire building system 1, the design freedom of the installation position of the shaping former 5 becomes increased since the shaping former 5 can orient to a wide range by rotating the turntable 4. Thus, the layout of the first drum and second drum becomes flexible.

First Transfer Device 6

The first transfer device 6 is horizontally movable between the first drum 2 and one of the shaping formers 5 which are aligned concentrically as shown in FIG. 1, FIG. 2 and FIG. 4, for example by the use of guide rails on the floor.

The first transfer device 6 is substantially tubular and has a central hole accommodating the first drum 2 on which the tire constructional components (b) is wound as shown in FIG. 4.

The first transfer device 6 in this embodiment can support an assembly of the bead core (c) and the rubber bead apex (f) adhered to the outer surface of the bead core (c). In order to place the bead cores (c) on the outside of the tire constructional components (b) wound on the first drum 2 and thereby to form the green tire main body B, as shown in FIG. 1 by imaginary line, the first transfer device 6 can move to a position P1 at which the first drum 2 is covered.

In order that the green tire main body B is picked up from the contracted first drum 2 in this position P1, the first transfer device 6 comprises a suction device or the like for that purpose.

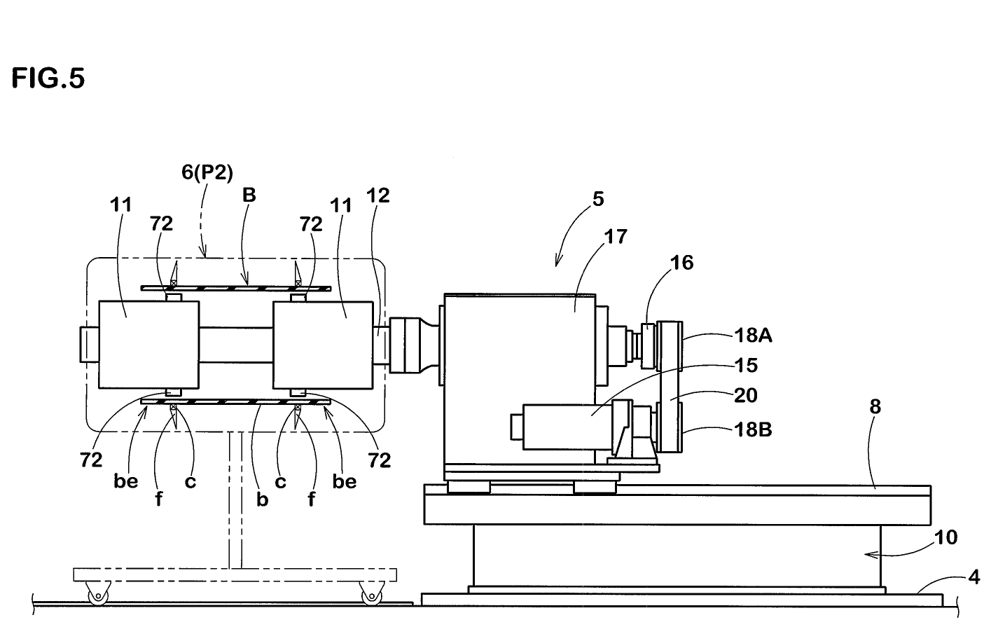

As shown in FIG. 1 and FIG. 5, the first transfer device 6 can move horizontally to a position P2 near the shaping former 5 in order to place the picked-up green tire main body B in a position radially outside the undermentioned bead-lock devices 11 of the shaping former 5 protruding from the turntable 4. When the green tire main body B is set on the shaping former 5, the shaping former 5 is moved on the rails 8 and the bead-lock devices 11 return to the position on the turntable 4.

### Second Transfer Device 7

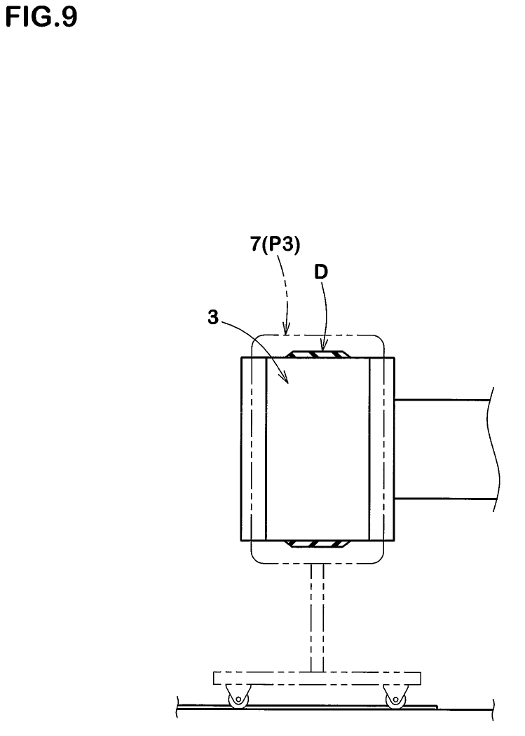

The second transfer device 7 is as shown in FIG. 1, movable between the second drum 3 and the shaping former 5 for example by the use of guide rails on the floor. Similarly to the first transfer device 6, the second transfer device 7 is substantially tubular and has a central hole accommodating the second drum 3. As shown in FIG. 1 and FIG. 9, the second transfer device 7 can move to a position P3 for covering the second drum 3 and picking the tread ring D up from the second drum 3. The picking-up is possible by suctioning the outer circumferential surface of the tread ring D for example. As shown in FIG. 9, the second transfer device 7 can move to a position P4 of the shaping former 5 in order to place the tread ring D radially outside the green tire main body B wound on the shaping former 5.

### Shaping Former 5

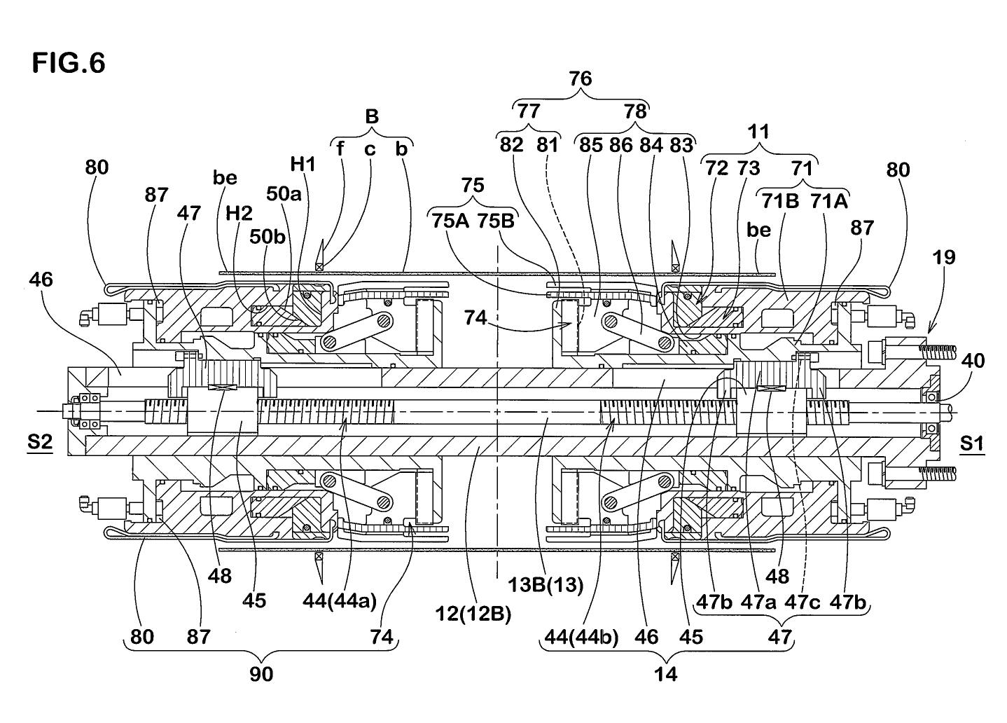

FIG. 3 shows the overall structure of the shaping former 5 in this embodiment. FIG. 6 shows a cross section of the substantial part of the shaping former 5.

The shaping former 5 comprises:
the above-mentioned two bead-lock devices 11;
a tubular shaft 12 for supporting the two bead-lock devices 11;
a central shaft 13 disposed in the tubular shaft 12 coaxially with the tubular shaft 12;
a rotational-to-linear motion converter 14;
an electric motor 15; and a clutch 16.

The tubular shaft 12 is as shown in FIG. 3, rotatably cantilever supported by the main frame 17 positioned on S1-side thereof. The end portion 12e of the tubular shaft 12 on S1-side protrudes from the main frame 17 towards S1-side.

The tubular shaft 12 has a central hole, and in this embodiment, is made up of a first tubular shaft 12A on S1-side and a second tubular shaft 12B on S2-side which are connected coaxially with a ferrule 19. The central hole extends continuously through the shafts 12A and 12B and ferrule 19.

The central shaft 13 is as shown in FIG. 3, disposed in the central hole of the tubular shaft 12, and extends coaxially with the tubular shaft 12. Both end portions of the central shaft 13 are supported by the tubular shaft 12 through bearings 40 so that the central shaft 13 is rotatable independently from the rotation of the tubular shaft 12.

In this embodiment, the central shaft 13 is made up of a first central shaft 13A on S1-side and a second central shaft 13B on S2-side which are connected at a position inside the tubular shaft 12. It is of course possible to use the single continuous central shaft 13.

In either case, as shown in FIG. 3, the end portion 13e of the central shaft 13 on S1-side protrudes from the end portion 12e of the tubular shaft 12 towards S1-side, and a first pulley 18A is fixed to this protruding end portion 13e.

Meanwhile, the electric motor 15 is mounted on the main frame 17 using a bracket or the like, and the output shaft of the electric motor 15 is coupled with a reduction gear system G. A second pulley 18B is fixed to the output shaft of the reduction gear system G. A belt 20 is wound between the first pulley 18A and the second pulley 18B. Therefore, by operating the electric motor 15, the central shaft 13 rotates. The rotational speed and rotational directions of the motor 15 are controlled by a computer-aided controlling device.

### Bead-Lock Devices 11

The bead-lock devices 11 are mounted coaxially each other so that their rotational axis is laid horizontally. As shown in FIG. 6, each of the bead-lock devices 11 comprise;
an expandable-and-contractible bead-lock ring 72;
an annular central support 71 for supporting the bead-lock ring 72 axially movably along the tubular shaft 12; and
an annular piston 73 disposed in the central support 71 for expanding or contracting the bead-lock ring 72.

In the position radially inside the bead cores (c) of the green tire main body B, by expanding the bead-lock rings 72, the tire constructional components (b) such as carcass plies are secured between the expanded bead-lock rings 72 and the inextensible bead cores (c) outside the bead-lock rings 72.

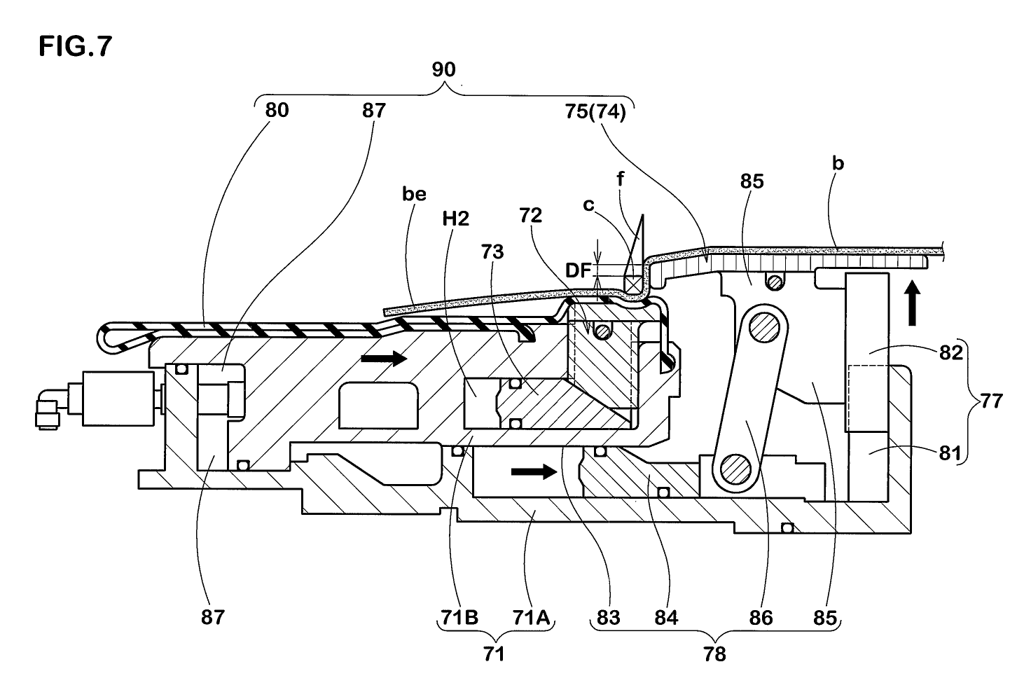

In this embodiment, the central support 71 comprises: a radially inner central support 71A mounted on the tubular shaft 12; and a radially outer central support 71B mounted on the radially inner central support 71A. Between the radially inner central support 71A and the radially outer central support 71B, as shown in FIG. 7, an air chamber 87 is formed, therefore, by supplying high-pressure air to the air chambers 87, the radially outer central support 71B can slide on the radially inner central support 71A relatively toward the axially inside.

The radially outer central support 71B is provided with a bead-lock-ring room H1 accommodating the bead-lock ring 72 and guiding the bead-lock ring 72 in the radial direction only, and a piston room H2 accommodating the piston 73 and guiding the piston 73 in the axial direction only.

By supplying high-pressure air to the piston room H2, the piston 73 moves axially inwards.

The axially inner end portion of the piston 73 is tapered to have a tapered surface 50a.

The bead-lock ring 72 is made up of a plurality of circumferentially-divided arch-shaped segments.

The radially inner end portion of each of the segments is provided with a tapered surface 50b. This tapered surface 50b slidably contacts with the tapered surface 50a of the piston 73. As a result, by moving the piston 73 axially inwards, the ring segments are moved radially outwards. Thus, the axial motion of the piston 73 is converted to the radial motion (or expansion) of the bead-lock ring 72.

Incidentally, instead of the tapered surface 50b, rollers (not shown) can be provided at the inner end of the segment in order to reduce the friction with the piston 73.

By the expansion of the bead-lock rings 72, as described above, the bead portions (bead cores) of the green tire main body B can be locked on the shaping former 5.

### Folding Device 90

In this embodiment, each of the shaping formers 5 further comprises a folding device 90 which can fold down the radially extending bead apex (f) towards the axially inside and turn up a carcass ply edge portion around the bead core.

As shown in FIG. 6 and FIG. 7, the folding device 90 comprises: a bladder 80 inflatable by supplying high-pressure air; and an expandable-and-contractible drum 74.

The bladder 80 has to be positioned radially inside each of the edge portions (be) of the carcass ply (b) protruding axially outwardly from the bead core (c).

The expandable-and-contractible drum 74 is disposed axially inside the bead-lock device 11.

The expandable-and-contractible drum 74 comprises:
a plurality of circumferentially divided segments 75; and
a plurality of radial guide supports 76 for the respective segments 75.

The segments 75 include first segments 75A and second segments 75B which are arranged alternately in the circumferential direction. When the segments 75A and 75B are in a certain radial position by being guided by the radial guide supports 76, the segments 75A and 75B can form a substantially continuous outer circumferential surface.

The radial guide supports 76 each comprise: a radial guide 77 for guiding each of the segments 75A, 75B in the radial direction; and

an expanding-and-contracting device 78 for radially moving the segments 75A and 75B guided by the radial guides 77.

Each of the radial guides 77 comprises: a radially extending guide plate 81 disposed on the axially inside of the radially inner central support 71A; and a moving plate 82 movable in the radially direction guided by the guide plate 81.

The expanding-and-contracting device 78 comprises:
an axially extending piston room 83 formed in the central support 71;
an annular piston 84 disposed in the piston room 83 slidably in the axial direction; and
a plurality of radially extending links 86. One end portion of each of the links 86 is pivoted to the piston 84, and the other end portion is pivoted to a mounting portion 85 of one of the moving plates 82. Also, one of the segments 75 is attached to the radially outer end of the mounting portion 85.

By supplying high-pressure air to the piston room 83, the piston 84 moves axially inward.

The above-mentioned rotational-to-linear motion converter 14 comprises as shown in FIG. 6:
two ball screws 44 formed on the central shaft 13;
two ball nuts 45 engaged with the two ball screws 44, respectively;
two axially extending long guide holes 46 formed on the tubular shaft 12; and
two connecting parts 47 each fixed to the radially outer central support 71B of one of the bead-lock devices 11 and extending radially inwardly through one of the guide holes 46 and coupled with one of the ball nuts 45.

The ball screws 44 include a right-hand screw 44a on S2-side and a left-hand screw 44b on S1-side, which are formed on the above-mentioned second central shaft 13B in this embodiment.

The ball nuts 45 have an outer diameter less than the inner diameter of the tubular shaft 12 so that, within the central hole of the tubular shaft 12, the ball nuts 45 can move axially along the ball screws 44.

The guide holes 46 include a guide hole on S1-side and a guide hole on S2-side, which are formed on the above-mentioned second tubular shaft 12B in this embodiment correspondingly to the screws 44a and 44b.

The connecting parts 47 each comprises: a main portion 47a extending radially through the guide hole 46; a protruding portion 47c protruding radially outwardly from the main portion 47a; and a pair of protruding portions 47b protruding radially inwardly from the main portion 47a so that the ball nut 45 is sandwiched therebetween.

The radially outwardly protruding portion 47c is fixed to a side face of the radially outer central support 71B, and the main portion 47a is fixed to the ball nut 45 with fastening means 48 such as key or the like. Thus, when the ball nuts 45 are moved axially, the bead-lock devices 11 are also moved together.

When the central shaft 13 is rotated relatively to the tubular shaft 12, the rotational-to-linear motion converter 14 can convert the rotational motion of the central shaft 13 to the linear motion of the ball nuts 45.

For example, if the tubular shaft 12 is not rotated and the central shaft 13 is rotated, since the guide holes 46 of the stopped tubular shaft 12 do not allow the rotation of the ball nuts 45, the ball nuts 45 move axially along the guide hole 46 in opposite directions due to the right-hand screw 44a and the left-hand screw 44b.

And together with the ball nuts 45, the bead-lock devices 11 and connecting parts 47 are moved along the tubular shaft 12 in opposite directions so as to come close to each other or get away from each other.

### Clutch 16

The above-mentioned clutch 16 is provided in order to switch between: a rotational-motion mode in which the two bead-lock devices 11 are rotated together; and a linear-motion mode in which the bead-lock devices 11 are moved axially in opposite directions.

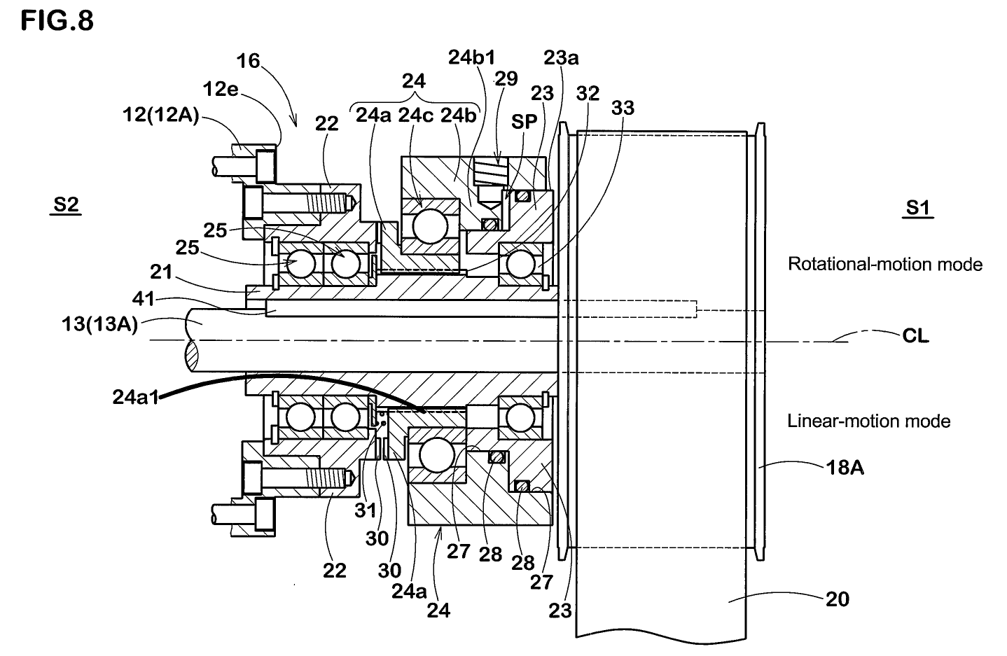

FIG. 8 shows the cross section of the clutch 16, wherein an upper half of FIG. 8 above the center line CL shows that in the rotational-motion mode, and the lower half of FIG. 8 shows that in the linear-motion mode.

The clutch 16 is disposed structurally between the end portion 12e of the tubular shaft 12 and the first pulley 18A, and functionally between the tubular shaft 12 and the central shaft 13.

The clutch 16 in this embodiment comprises a hub 21, a disk 22, an end support 23, a slider 24, a piston room SP, and a spring 31.

The hub 21 has a relatively long axial length and is fixed to the outer circumferential surface of the central shaft 13 with a key 41 so as to be rotatable together with the central shaft 13.

The disk 22 is mounted on the hub 21 on S2-side through a bearing 25 so as to be rotatable independently from the rotation of the hub 21. The disk 22 is fixed to the end portion 12e of the tubular shaft 12 (first tubular shaft 12A in this embodiment) with bolts so as to be rotatable together with the tubular shaft 12.

The end support 23 is mounted on the hub 21 on S1-side through a bearing 33 so as to be rotatable independently from the rotation of the hub 21 but immovably in the axial direction.

The spring 31 biases the slider 24 towards the end support 23.

The slider 24 is movable axially between the disk 22 and the end support 23 along the hub 21. The slider 24 comprises: an inner ring portion 24a mounted on the hub 21 movably only in the axial direction and being rotatable together with the hub 21; an outer ring portion 24b mounted on the radially outer surface 23a of the end support 23 movably in the axial direction; and a bearing 24c rotatably connecting between the inner ring portion 24a and the outer ring portion 24b.

The inner ring portion 24a and the outer ring portion 24b can rotate independently from each other, but can move together in the axial direction.

The inner circumferential surface of the inner ring portion 24a is provided with a plurality of axially extending grooves 24a1. The outer circumferential surface of the hub 21 is provided with a plurality of axially extending ribs 32 engaging with the grooves 24a1. Therefore, between the inner ring portion 24a and the hub 21, relative motion in the axial direction is allowed, but relative rotational motion is not allowed.

The surfaces of the inner ring portion 24a and disk 22 which face each other, are each provided with an annular friction plate 30 provided on the contacting surfaces with teeth, serrations or the like not to cause slippage.

By moving the inner ring portion 24a towards the disk 22, the friction plates 30 are engaged with each other as shown in the upper half of FIG. 8, and the rotational motion of the inner ring portion 24a or the central shaft 13 is transmitted to the disk 22.

By moving the inner ring portion 24a towards the end support 23 due to the biasing force of the spring 31, the friction plates 30 separate from each other as shown in the lower half of FIG. 8, accordingly, the rotational motion is not transmitted to the disk 22.

The above-mentioned piston room SP is formed between the slider 24 and end support 23. By supplying high-pressure air into the piston room SP, the slider 24 moves towards the disk 22 against the biasing force of the spring 31.

In order to increase the airtightness of the piston room SP, between the sliding surfaces 27 of the outer ring portion 24b and end support 23, there is disposed an O-ring 28 on each side of the piston room SP in the axial direction.

The outer ring portion 24b is provided in the outer surface thereof with an opening of an air flow passage 29. The passage 29 extends in the outer ring portion 24b and opens at the piston room SP in order to supply or discharge the high-pressure air.

Next, the function of the green tire building system 1 and a method for manufacturing the green tire using the same will be described in detail.

When the green tire main body B is set on the shaping former 5 by the first transfer device 6, the rubber bead apexes (f) are folded down and pressure bonded to the central portion (bc) of the tire constructional components (b), and further the carcass ply edge portions (be) axially outside the bead cores (c) are turned up around the bead cores (c).

When high-pressure air is supplied to the air chambers 83, the pistons 84 are moved axially inwardly as shown in FIG. 7. By the axially inward movement, the above-mentioned segments 75 supported and guided by the mounting portions 85, the radial guides 77 are moved radially outwards by the links 86, therefore, each of the drums 74 expands.

The expanded drams 74 can swell the central main portion of the tire constructional components (namely, carcass plies and innerliner rubber) between the bead cores (c) locked by the bead-lock rings 72.

Therefore, a tension is applied to the carcass cords between the bead cores in order to prevent the carcass cord arrangement from being disturbed during folding the bead apexes and turning up the carcass ply edge portions.

The outer circumferential surface of the expanded drum 74 is positioned radially outside that of the bead cores (c). Namely, a step DL in the radial direction is formed between the outer circumferential surfaces of the drum 74 and bead cores (c). This step DL facilitates the contact between the axially inwardly folded rubber bead apex and the tire constructional components (b).

In order to press the axially inner surfaces of the bead cores (c) against the side faces of the expanded drum 74 (more specifically, the side faces of the segments) through the tire constructional components (b) as shown in FIG. 7, the radially outer central supports 71B are moved axially inwardly together with the bead-lock rings 72 by supplying high-pressure air to the above-mentioned air chambers 87.

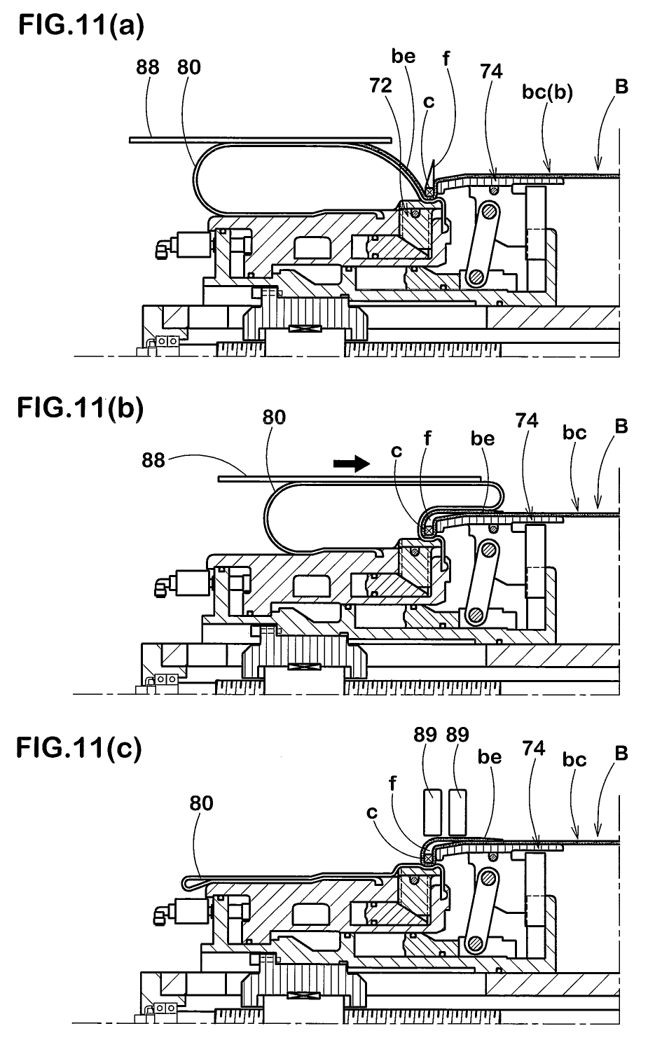

Then, as shown in FIGS. 11(a) and 11(b), the bladder 80 is inflated so that the inflated bladder contacts with the radially inner surface of a press plate 88 disposed around the radially outside of the bladder 80, and the press plate 88 is moved axially inwards. Thereby, the bladder 80 is forced toward the axially inside and can turn up the carcass ply edge portion (be) and fold down the rubber bead apex (f) axially inward. Furthermore, the bladder 80 can adhere these to the central portion (bc) of the tire constructional components (b).

In order to ensure the adhesion, as shown in FIG. 11(c), the folded bead apex and turned-up carcass ply edge portion are pressed against the central portion by the use of pressure rollers 89 for example.

Meanwhile, a strip of sidewall rubber (s) is supplied from a sixth service tray t6 to the green tire main body B on the shaping former 5, and the sidewall rubber (s) strip is wound and applied thereto.

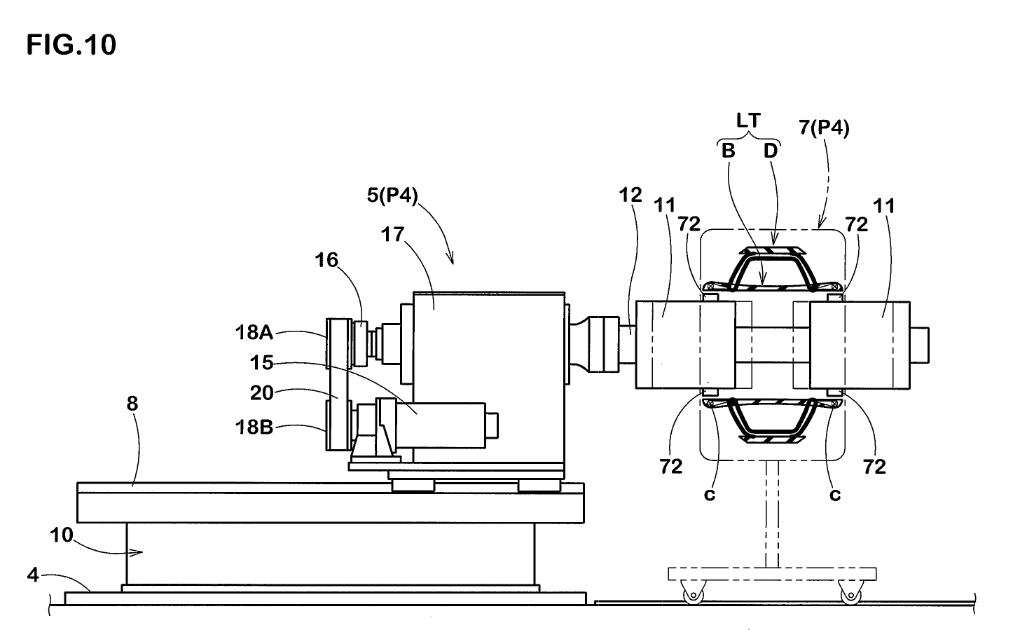

Thereafter, the turntable 4 is turned by 180 degrees, and the shaping former 5 is moved horizontally towards the second drum 3 so that the green tire main body B on the shaping former 5 is inserted in the tread ring D supported by the second transfer device 7 as shown in FIG. 10.

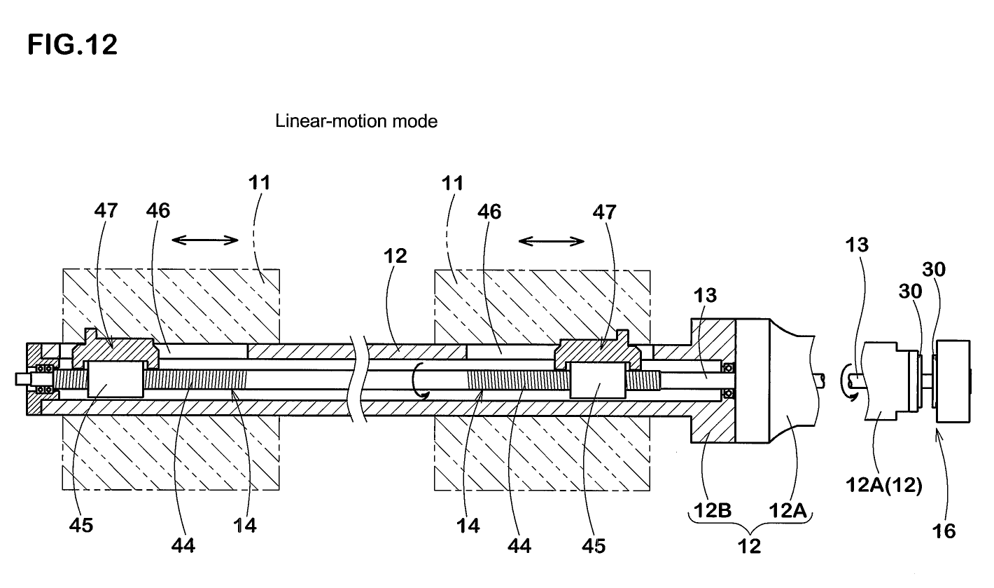

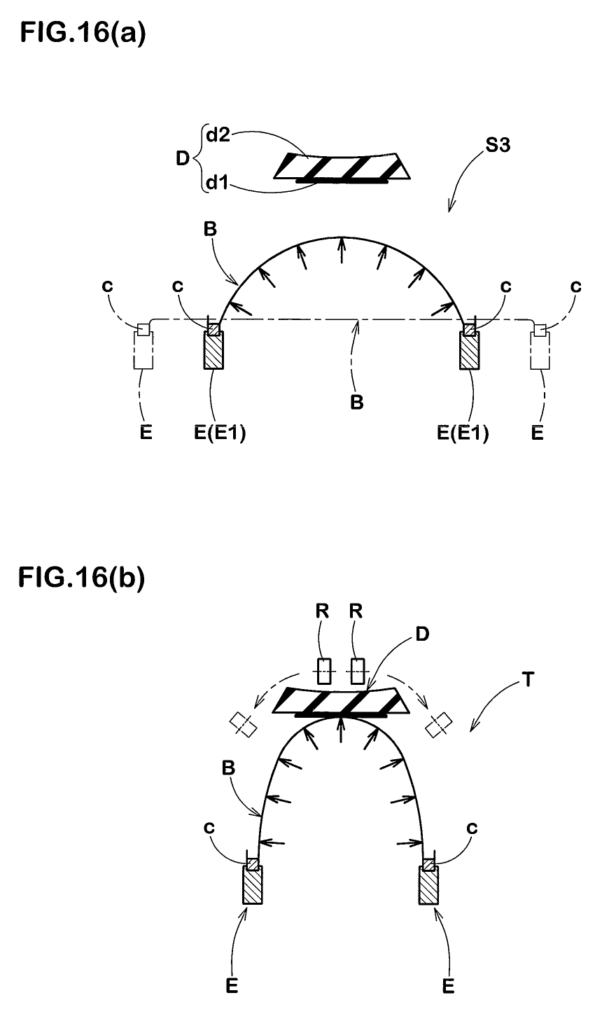

Next, on the shaping former 5, in order to carry out the steps as shown in FIGS. 16(a)-16(b), the clutch 16 is switched to the linear-motion mode by discharging the high-pressure air from the piston room SP. Thereby, the slider 24 is forced towards the end support 23 by the spring 31 and separates from the disk 22. In this separated state, the electric motor 15 is operated to rotate the central shaft 13 only through the belt 20 and first pulley 18A. Specifically, the inner ring portion 24a is rotated by the hub 21 fixed to the central shaft 13 with the key 41, but the tubular shaft 12 is not rotated since the disk 22 separates from the inner ring portion 24a. As a result, a relative rotational motion is caused between the tubular shaft 12 and central shaft 13, and as shown in FIG. 12, the two bead-lock devices 11 can come close to each other or get away from each other according to the rotational direction.

Therefore, without rotating the green tire main body B, as shown in FIG. 10 by imaginary line, the distance between the bead cores (c) is decreased and the green tire main body B is swelled into a toroidal shape by filling up the inside of the green tire main body B with air. And the crown portion of the swelled green tire main body B is adhered to the inner circumferential surface of the tread ring D to form the green tire LT. Thereafter, the second transfer device 7 is moved away from the shaping former 5.

Next, the clutch 16 is switched to the rotational-motion mode by supplying high-pressure air to the piston room SP, thereby the slider 24 is moved towards the disk 22 and the friction plate 30 of the inner ring portion 24a engages with the friction plate 30 of the disk 22.

In this engaged state, the electric motor 15 is operated. As a result, the electric motor 15 can rotate not only the central shaft 13 but also the disk 22 through the hub 21 and inner ring portion 24a.

Thus, both of the central shaft 13 and tubular shaft 12 are rotated without relative rotational motion therebetween.

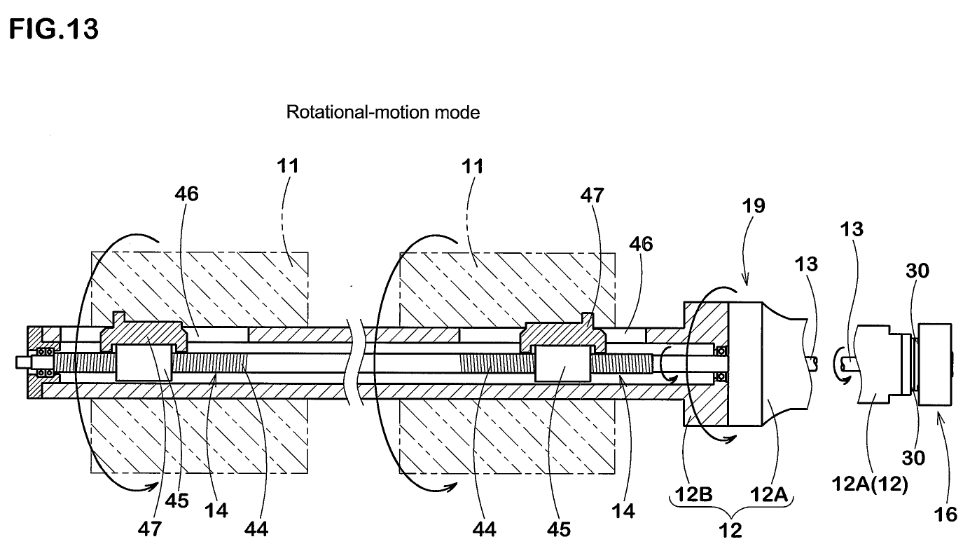

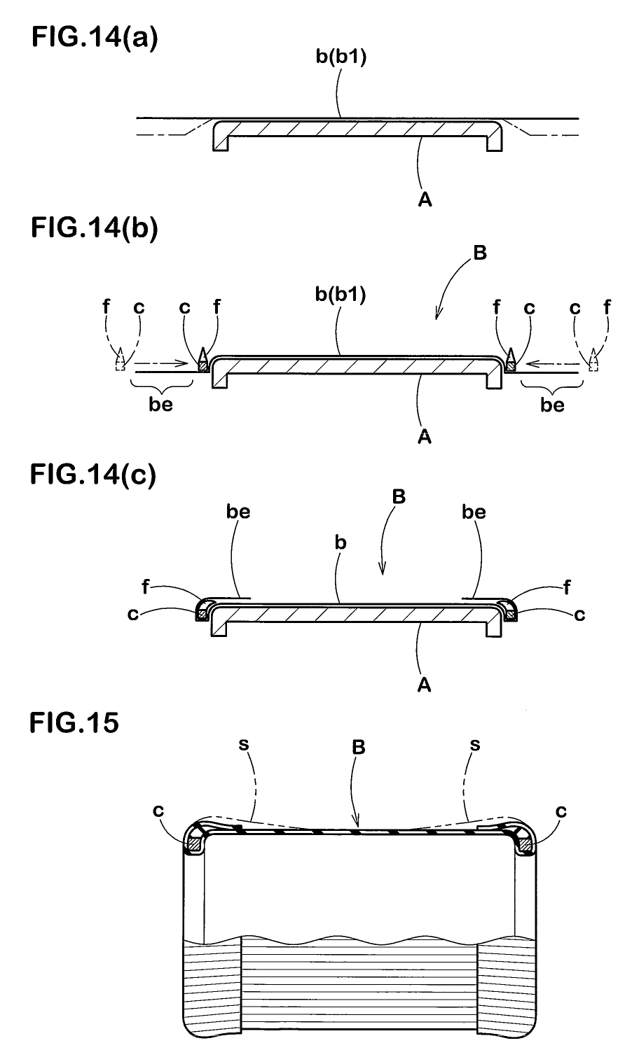

Accordingly, the bead-lock devices 11 are rotated while keeping the axial distance therebetween constant as shown in FIG. 13.

Thereby, the sticking step as shown in FIG. 16(b) is possible and the green tire LT can be finished.

Incidentally, the rotational-motion mode is also used in the process shown in FIG. 11(c).

The finished green tire is took out from the shaping former 5. Then, the shaping former 5 returns to the position on the turntable, and the turntable 4 is turned 180 degrees so as to position towards the first drum 2 to repeat the above described series of steps.

As explained above, the shaping former 5 has the clutch 16 switching the transmission of the rotational motion of the single electric motor 15 between the linear-motion mode and rotational-motion mode, therefore, the structure is simplified.

The clutch 16 in this embodiment utilizes high-pressure air, but it is also possible to use another type of clutch utilizing electromagnet, oil pressure or the like.

1. A shaping former used for shaping a green tire main body comprising a carcass ply wound into a substantially cylindrical shape and a pair of bead cores fitted thereon such that a portion of the carcass ply between the bead cores is swelled while decreasing the distance between the bead cores, said shaping former comprising:
a pair of bead-lock devices disposed side-by-side in the axial direction of the former and supporting the green tire main body at the positions of the bead cores from the radially inside of the green tire main body;
a rotatable tubular shaft supporting the bead-lock devices movably therealong but immovably therearound;
a central shaft disposed in the tubular shaft and being rotatable independently of the tubular shaft;
a motion converter converting rotational motion of the central shaft relative to the tubular shaft to linear motion for causing the bead-lock devices to come close to each other or to get away from each other;
a single electric motor; and
a clutch for switching transmission of the rotational motion of the single electric motor between a linear-motion mode and a rotational-motion mode, wherein
the linear-motion mode is such that the rotational motion of the single electric motor is transmitted to only the central shaft so as to cause the rotational motion of the central shaft relative to the tubular shaft, whereby the bead-lock devices come close to each other or get away from each other according to the direction of the rotational motion, and
the rotational-motion mode is such that the rotational motion of the single electric motor is transmitted to both of the tubular shaft and central shaft so that the bead-lock devices rotate together, without causing the relative rotational motion between the central shaft and the tubular shaft.

2. A green tire building system comprising:
two of the shaping formers as set forth in claim 1;
a first drum on which the cylindrical green tire main body is formed by winding the carcass ply and fitting the bead cores on the wound carcass ply;
a second drum on which an annular tread ring is formed by winding a tread reinforcing belt and a tread rubber; and
a turntable on which said two shaping formers are installed, the turntable is positioned between the first drum and the second drum so that by turning the turntable, each of the shaping formers is positioned toward and concentrically with the first drum and the second drum in turn.

3. The green tire building system according to claim 2, which further comprises
a device for moving each of the shaping formers horizontally on the turntable so that the bead-lock devices thereof protrudes from the turntable.

4. The green tire building system according to claim 2 or 3, which further comprises
a first transfer device for transferring the green tire main body from the first drum to the shaping former.

5. The green tire building system according to claim 2 or 3, which further comprises
a second transfer device for transferring the tread ring from the second drum to the shaping former.

6. The green tire building system according to claim 2 or 3, which further comprises
a first transfer device for transferring the green tire main body from the first drum to the shaping former, and
a second transfer device for transferring the tread ring from the second drum to the shaping former.
